(19) United States
(12) Patent Application Publication
(10) Pub. No.: US 2018/0056681 A1
(43) Pub. Date: Mar. 1, 2018

(54) LABEL RIBBON CARTRIDGE PROVIDED WITH IDENTIFICATION SHEET SUPPORTING MEMBER

(71) Applicant: AIMO MARKING CO., LTD, Zhuhai (CN)

(72) Inventors: Wei Du, Zhuhai (CN); Jinpeng Guo, Zhuhai (CN)

(21) Appl. No.: 15/686,402

(22) Filed: Aug. 25, 2017

(30) Foreign Application Priority Data
Aug. 25, 2016 (CN) 201620945190.9

(51) Int. Cl. B41J 15/04; B41J 17/36; B41J 35/36

(52) U.S. Cl. CPC B41J 15/044; B41J 3/4075; B41J 35/36; B41J 17/36

(57) ABSTRACT

The disclosure relates to a label ribbon cartridge provided with an identification sheet supporting member, a detection surface of a detection arm of which is provided with an identification sheet that is horizontally suspended in air; a supporting member is arranged on a lower surface of the identification sheet, a lower end of the supporting member is in contact connection with the detection surface of the detection arm or is close to the detection surface of the detection arm in a non-contact manner. The label ribbon cartridge provided with an identification sheet supporting member is stable and reliable in performance, simple in structure and easy in production and processing.

### CROSS-REFERENCE TO RELATED APPLICATION

This application claims priority to Chinese Application No. 201620945190.9 filed on Aug. 25, 2016, the entire contents of which are hereby incorporated by reference.

### TECHNICAL FIELD

The disclosure belongs to the technical field of label ribbon cartridges, and in particular to a label ribbon cartridge provided with an identification sheet supporting member.

### BACKGROUND

At present, all label ribbon cartridges available on the market are provided with different identification structures on the detection surface of detection arms to be applicable to different models of printers, for example, some factories adopt an identification structure in which an identification hole is arranged on the detection surface, and some factories adopt an identification structure which is formed by an identification groove and an identification sheet that is horizontally suspended in the identification groove. Herein, the identification sheet in the structure formed by the identification groove and the identification sheet is easy to sink, bend and deform, even break off when the label ribbon cartridge is repeatedly put into a printer to be used for a long time, finally causing that the label ribbon cartridge cannot conduct identification and cannot be used normally and that the service life thereof is greatly shortened.

### SUMMARY

In order to solve the above technical problem in existing technologies, the disclosure provides a label ribbon cartridge which can effectively support the identification sheet, avoids the sinking, bending and deforming, and breaking off of the identification sheet, has long service life, and is stable and reliable in performance, simple in structure, and easy in production and processing.

In order to solve the above technical problem, the disclosure adopts a technical scheme as follows.

A label ribbon cartridge provided with an identification sheet supporting member includes a detection arm of which a detection surface is provided with an identification sheet that is horizontally suspended in air; a supporting member is arranged on a lower surface of the identification sheet, a lower end of the supporting member is in contact connection with the detection surface of the detection arm or is close to the detection surface of the detection arm in a non-contact manner.

Further, the supporting member and the identification sheet are integrally injection-molded.

A label ribbon cartridge provided with an identification sheet supporting member includes a detection arm of which a detection surface is provided with an identification sheet that is horizontally suspended in air; a supporting member is arranged at the position on the detection surface of the detection arm below the identification sheet, an upper end of the supporting member is in contact connection with a lower surface of the identification sheet or is close to the lower surface of the identification sheet in a non-contact manner.

Further, the supporting member and the detection surface of the detection arm are integrally injection-molded.

Further, the supporting member is a vertically arranged elastic supporting member.

Further, the detection surface of the detection arm is provided with an identification concave surface, the identification sheet is horizontally suspended above the identification concave surface, and the lower end of the supporting member is in contact connection with the identification concave surface or is close to the identification concave surface in a non-contact manner.

Further, the detection surface of the detection arm is provided with an identification concave surface, the identification sheet is horizontally suspended above the concave surface, the supporting member is arranged on the identification concave surface, and the upper end of the supporting member is in contact connection with the lower surface of the identification sheet or is close to the lower surface of the identification sheet in a non-contact manner.

Further, the rim of the detection surface of the detection arm is provided with a limiting bulge, the end face of the limiting bulge and the identification sheet are located on the same surface, and one end of the identification sheet is bended downwards vertically and connected with the rim of the detection surface.

Further, the limiting bulge and the identification sheet are integrally injection-molded with a shell of the detection arm.

The disclosure has benefits as follows.

Through the above technical scheme, the disclosure can effectively support the identification sheet, avoiding defects that the label ribbon cartridge cannot be normally used and the service life thereof is greatly shortened due to the sinking, bending and deforming, even breaking off of the identification sheet after a long time of usage; the label ribbon cartridge provided with an identification sheet supporting member is stable and reliable in performance, simple in structure and easy in production and processing.

### BRIEF DESCRIPTION OF THE DRAWINGS

The disclosure is described below in further detail in conjunction with accompanying drawings and specific embodiments.

FIG. 1 is a structure diagram of an Embodiment 1 of a label ribbon cartridge provided with an identification sheet supporting member according to the disclosure.

FIG. 2 is a partial structure diagram of the Embodiment 1 of a label ribbon cartridge provided with an identification sheet supporting member according to the disclosure.

FIG. 3 is a partial structure diagram of an Embodiment 2 of a label ribbon cartridge provided with an identification sheet supporting member according to the disclosure.

FIG. 4 is a partial structure diagram of an Embodiment 3 of a label ribbon cartridge provided with an identification sheet supporting member according to the disclosure.

### DESCRIPTION OF THE EMBODIMENTS

The purpose, the technical scheme and the advantages of the disclosure will become more clearly understood from the detailed description of the disclosure below taken in conjunction with accompanying drawings and embodiments. It should be understood that the specific embodiments described below are merely to illustrate, but to limit, the disclosure.

### Embodiment 1

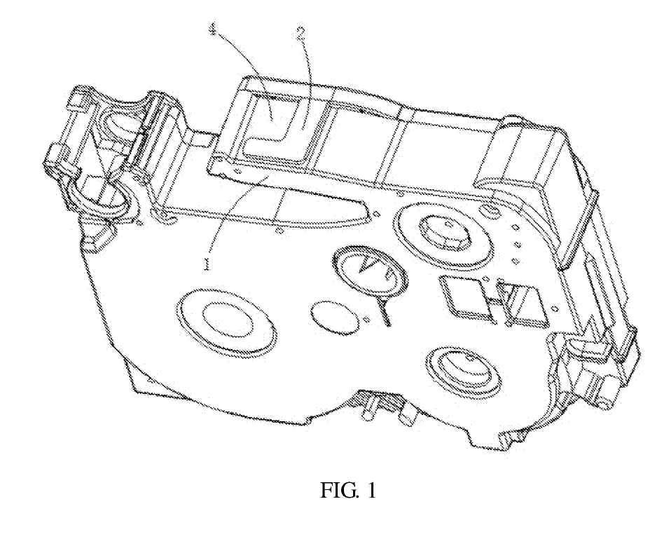

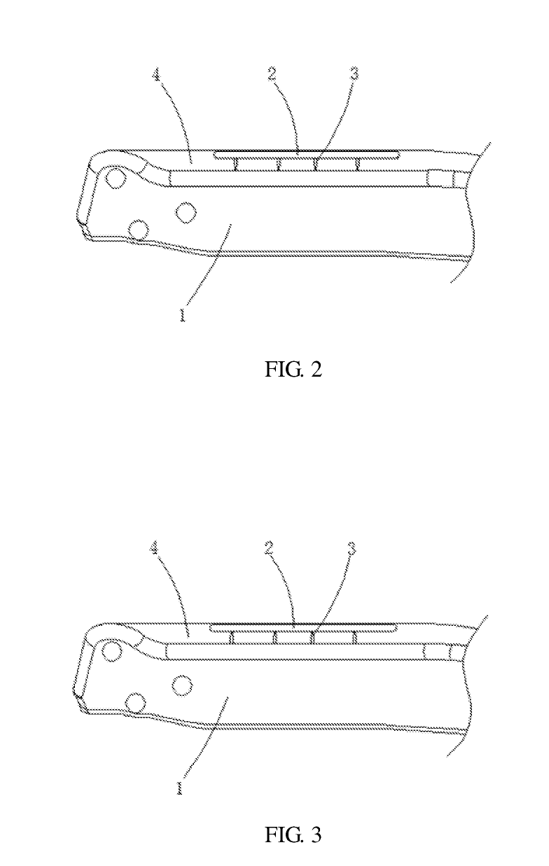

As shown in FIG. 1 and FIG. 2, the Embodiment 1 of the disclosure provides a label ribbon cartridge provided with an identification sheet supporting member, a detection surface of a detection arm 1 of which is provided with an identification sheet 2 that is horizontally suspended in air; a supporting member 3 is arranged on a lower surface of the identification sheet 2, a lower end of the supporting member 3 is in contact connection with the detection surface of the detection arm 1 (also may be close to the detection surface of the detection arm 1 in a non-contact manner). The specific structure may be: the detection surface of the detection arm 1 is provided with an identification concave surface 4, the identification sheet 2 is horizontally suspended above the concave surface 4, and the lower end of the supporting member 3 is in contact connection with the identification concave surface 4 (also may be close to the identification concave surface 4 in a non-contact manner), wherein the supporting member 3 may be a vertically arranged elastic supporting member and is integrally injection-molded with the identification sheet 2.

When the label ribbon cartridge described in the Embodiment 1 of the disclosure is installed into a printer to be used, the supporting member 3 effectively supports the identification sheet 2, avoiding defects that the label ribbon cartridge cannot be normally used and the service life thereof is greatly shortened due to the sinking, bending and deforming, even breaking off of the identification sheet 2 after a long time of usage; the label ribbon cartridge is stable and reliable in performance, simple in structure and easy in production and processing.

### Embodiment 2

As shown in FIG. 3, the Embodiment 2 of the disclosure provides a label ribbon cartridge provided with an identification sheet supporting member, the structure of which is basically the same as the Embodiment 1 and a detection surface of a detection arm 1 of which is provided with an identification sheet 2 that is horizontally suspended in air; a supporting member 3 is arranged at the position on the detection surface of the detection arm 1 below the identification sheet 2, an upper end of the supporting member 3 is in contact connection with a lower surface of the identification sheet 2 or is close to the lower surface of the identification sheet 2 in a non-contact manner. The specific structure may be: the detection surface of the detection arm 1 is provided with an identification concave surface 4, the identification sheet 2 is horizontally suspended above the identification concave surface 4, the supporting member 3 is arranged on the identification concave surface 4, and the upper end of the supporting member 3 is in contact connection with the lower surface of the identification sheet 2 or is close to the lower surface of the identification sheet 2 in a non-contact manner. Herein, the supporting member 3 may be a vertically arranged elastic supporting member and is integrally injection-molded with the detection surface of the detection arm 1.

When the label ribbon cartridge described in the Embodiment 2 of the disclosure is installed into a printer to be used, the supporting member 3 also effectively supports the identification sheet 2, avoiding defects that the label ribbon cartridge cannot be normally used and the service life thereof is greatly shortened due to the sinking, bending and deforming, even breaking off of the identification sheet 2 after a long time of usage; the label ribbon cartridge is stable and reliable in performance, simple in structure and easy in production and processing.

### Embodiment 3

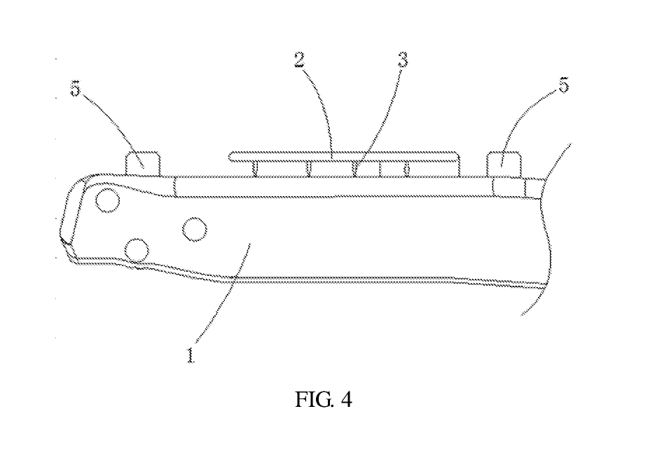

As shown in FIG. 4, the Embodiment 3 of the disclosure provides a label ribbon cartridge provided with an identification sheet supporting member, the structure of which is basically the same as the Embodiment 1 and Embodiment 2 and the rim of a detection surface of a detection arm 1 of which is provided with a limiting bulge 5, wherein the end face of the limiting bulge 5 and the identification sheet 2 are located on the same surface, the limiting bulge 5 and the identification sheet 2 are integrally injection-molded with a shell of the detection arm 1, one end of the identification sheet 2 is bended downwards vertically and connected with the rim of the detection surface, meanwhile, a supporting member 3 is arranged on a lower surface of the identification sheet 2 (of course, the supporting member 3 also may be arranged on the detection surface of the detection arm 1). In this way, not only the identification sheet 2 is ensured not to sink, bend and deform, even break off, but also the size of the detection arm 1 is further reduced, thus, the used material is reduced and the cost is lowered.

The above are the preferred implementations of the disclosure. It should be noted that, for the ordinary skill in this art, multiple improvements and modifications may be made without departing from the principle of the disclosure, and these improvements and modifications shall fall into the scope of protection of the disclosure.

What is claimed is:

1. A label ribbon cartridge provided with an identification sheet supporting member, a detection surface of a detection arm (1) of which is provided with an identification sheet (2) that is horizontally suspended in air, characterized in that: a supporting member (3) is arranged on a lower surface of the identification sheet (2), a lower end of the supporting member (3) is in contact connection with the detection surface of the detection arm (1) or is close to the detection surface of the detection arm (1) in a non-contact manner.

2. The label ribbon cartridge provided with an identification sheet supporting member according to claim 1, characterized in that: the supporting member (3) and the identification sheet (2) are integrally injection-molded.

3. A label ribbon cartridge provided with an identification sheet supporting member, a detection surface of a detection arm (1) of which is provided with an identification sheet (2) that is horizontally suspended in air, characterized in that: a supporting member (3) is arranged at the position on the detection surface of the detection arm (1) below the identification sheet (2), an upper end of the supporting member (3) is in contact connection with a lower surface of the identification sheet (2) or is close to the lower surface of the identification sheet (2) in a non-contact manner.

4. The label ribbon cartridge provided with an identification sheet supporting member according to claim 3, characterized in that: the supporting member (3) and the detection surface of the detection arm (1) are integrally injection-molded.

5. The label ribbon cartridge provided with an identification sheet supporting member according to claim 1, characterized in that: the supporting member (3) is a vertically arranged elastic supporting member.

6. The label ribbon cartridge provided with an identification sheet supporting member according to claim 1, characterized in that: the detection surface of the detection arm (1) is provided with an identification concave surface (4), the identification sheet (2) is horizontally suspended above the identification concave surface (4), and the lower end of the supporting member (3) is in contact connection with the identification concave surface (4) or is close to the identification concave surface (4) in a non-contact manner.

7. The label ribbon cartridge provided with an identification sheet supporting member according to claim 3, characterized in that: the detection surface of the detection arm (1) is provided with an identification concave surface (4), the identification sheet (2) is horizontally suspended above the concave surface (4), the supporting member (3) is arranged on the identification concave surface (4), and the upper end of the supporting member (3) is in contact connection with the lower surface of the identification sheet (2) or is close to the lower surface of the identification sheet (2) in a non-contact manner.

8. The label ribbon cartridge provided with an identification sheet supporting member according to claim 1, characterized in that: the rim of the detection surface of the detection arm (1) is provided with a limiting bulge (5), the end face of the limiting bulge (5) and the identification sheet (2) are located on the same surface, and one end of the identification sheet (2) is bended downwards vertically and connected with the rim of the detection surface.

9. The label ribbon cartridge provided with an identification sheet supporting member according to claim 8, characterized in that: the limiting bulge (5) and the identification sheet (2) are integrally injection-molded with a shell of the detection arm (1).
